(19) United States
(12) Patent Application Publication
(10) Pub. No.: US 2019/0023152 A1
(43) Pub. Date: Jan. 24, 2019

(54) ELECTRIC DRIVE RIGID REAR AXLE ASSEMBLY WITH STABILITY CONTROL

(71) Applicant: FORD GLOBAL TECHNOLOGIES, LLC, Dearborn, MI (US)

(72) Inventors: Ralf HINTZEN, Aachen (DE); Peter Christoph WOLFF, Aachen (DE)

(73) Assignee: FORD GLOBAL TECHNOLOGIES, LLC, Dearborn, MI (US)

(21) Appl. No.: 16/036,334

(22) Filed: Jul. 16, 2018

(30) Foreign Application Priority Data
Jul. 21, 2017 (DE) 10 2017 212 546.2

(51) Int. Cl. B60L 15/20; B60G 11/04; B60K 17/16; B60K 17/12; F16H 48/36

(52) U.S. Cl. CPC B60L 15/2036; B60G 11/04; B60K 2001/001; B60K 17/12; F16H 48/36; B60K 17/16

(57) ABSTRACT

A vehicle includes a body structure and a rear axle connecting two rear wheels and carried by two leaf spring units, each leaf spring unit being pivotably connected at one end to the body and at another end to a connection arm pivotably connected to the body structure, wherein the rear axle includes two driveshafts connecting the rear wheels. A drive unit is supported by the rear axle to be self-supporting relative to the body. The drive unit includes an electric motor coupled to at least one of the two drive shafts. A controller is configured to control the electric motor in response to lateral acceleration of the vehicle during cornering to deliver increased driving torque to an outer one of the two rear wheels relative to an inner one of the two rear wheels.

### CROSS-REFERENCE TO RELATED APPLICATIONS

This application claims foreign priority benefits under 35 U.S.C. § 119(a)-(d) to DE Application 10 2017 212 546.2 filed Jul. 21, 2017, which is hereby incorporated by reference in its entirety.

### TECHNICAL FIELD

This disclosure relates to a vehicle having a rear axle that connects two wheels, which can be driven differently via a drive unit having at least one electric motor where the rear axle and drive unit are supported by two leaf spring units.

### BACKGROUND

In motor vehicles, a wide variety of suspensions for the wheels of the vehicle are known. It is particularly possible to differentiate between the single wheel suspension which is used almost exclusively in cars today and the rigid axle suspension mainly used in the rear axles of utility vehicles. In the case of the latter, the wheels on both sides are seated on a single continuous axle which is normally spring-mounted relative to the vehicle structure via leaf springs or suspension arms. The rigid axle here can have a differential gear and/or be driven.

A typical construction of this type is a so-called Hotchkiss suspension in which a continuous axle is supported at both sides on individual leaf springs or leaf spring packs which extend in the longitudinal direction of the vehicle. Each of the leaf springs is pivotably connected at a front end to the vehicle structure, for example to a longitudinal beam. At a rear end, the connection is produced indirectly via connecting arms or bracket elements which are pivotably connected on the one hand to the leaf spring and pivotably connected on the other hand to the vehicle structure. Such connecting arms normally extend approximately perpendicularly. Their task is to enable longitudinal compensation upon the deformation of the leaf spring.

During cornering of the vehicle, a higher load acts on the suspension of the wheels on the outside of the curve than on the suspension of the wheels on the inside of the curve. Even when a stabilizer is connected to the rigid axle, there is still a stronger deflection on the side on the outside of the curve. Since the front attachment point of each leaf spring is fixedly connected with respect to the vehicle structure, whilst the rear is movable via the connecting arm, a deflection results not only in an upward displacement of the axle relative to the vehicle structure, but also a rearward displacement. Therefore, with an unequal deflection, the rigid axis is rotated slightly (about the vertical axis or yaw axis), wherein the wheel on the outside of the curve moves rearward relative to the wheel on the inside of the curve. This leads to oversteer, which is generally undesirable since it destabilizes the vehicle. It is possible to counteract this effect by increasing the spring rate or spring stiffness of the leaf springs. As a result of this, however, on the one hand, the leaf springs and therefore the vehicle as a whole generally become heavier; on the other hand, this has an effect on the general behavior of the leaf springs, i.e. the suspension becomes stiffer overall, which can in turn be disadvantageous. The leaf spring here has to be designed such that a certain roll stiffness is achieved to restrict the oversteer associated therewith via the axle kinematics. This is at the expense of comfort during the vertical deflection. Moreover, it is thus possible only to restrict the oversteer, but not to suppress it completely let alone bring about a desired understeer.

U.S. Pat. No. 9,120,479 B2 discloses an electric axle for a road vehicle having four wheels, which has an electric drive motor, which is arranged coaxially on the axle, and a first planetary gear, which is connected to the electric drive motor and a first side of the axle, and a second planetary gear, which is connected to the electric drive motor and a second side of the axle, wherein the first and second planetary gears form a differential mechanism. A torque vector unit has an electric motor, which is arranged coaxially on the axle and is connected to the differential mechanism in order to provide a change in the torque distribution between the first side and the second side of the axle by providing a torque difference for opposite ends of the axle, wherein the electric motor of the torque vector unit is connected to the first and second planetary gears.

US 2015/0065283 A1 discloses an electric drive axle arrangement for a road vehicle, having an electric drive motor, a differential mechanism which enables different speeds of drive wheels which are driven by the drive motor, and a torque vectoring system for controlling the distribution of the driving moments between the two drive wheels, wherein the torque vectoring system has a torque vectoring motor with non-permanent magnets.

With regard to the demonstrated prior art, the stabilization of a vehicle having a Hotchkiss suspension still offers room for improvements. This relates in particular to the steering behavior of the vehicle during cornering.

### SUMMARY

It should be pointed out that the features and measures presented individually in the description below can be combined with one another in any technically useful manner and demonstrate further embodiments of the disclosure. The description additionally characterizes and specifies the claimed subject matter in particular in conjunction with the figures.

An axle assembly is described herein. It goes without saying that this is an assembly which is provided in particular for motor vehicles such as trucks or cars. However, an application for trailers or semitrailers is, for example, also conceivable. The term “axle assembly” here is understood to mean that the elements of this assembly should be functionally associated with a vehicle axle or cooperate with the vehicle axle.

The axle assembly has a vehicle axis which connects two wheels which can be driven differently via a drive unit. This therefore refers to a rigid axle on which both wheels are arranged. However, the two wheels can be driven differently, i.e. they can be driven via the drive unit with different torques and/or different angular speeds. The drive unit here enables the two wheels to be driven differently. Normally, it has at least one motor and at least one gear. In some circumstances, the drive unit can also have only one gear, which is coupled to an external motor. The term “drive unit” here should be understood in purely functional terms and does not mean that the drive unit has to be physically united in one specific region. It is also possible that parts of the drive unit are spatially separate from one another.

Each leaf spring unit here serves to support the vehicle axle in such a way that a deflection is possible. The leaf spring unit extends along a vehicle longitudinal axis (X axis). At a front end, the leaf spring unit is pivotably connected (via a first pivot axis) to the vehicle structure. The leaf spring unit comprises at least one leaf spring, the shape of which can be designed differently within the scope of the disclosure, e.g. semi-elliptical, parabolic, wavelike etc. A plurality of leaf springs can form one or more spring packs here. The leaf spring units normally extend approximately in the direction of the longitudinal axis of the vehicle. The vehicle structure can be in particular a chassis and/or a body of the vehicle. Each of the leaf spring units supports the vehicle axle, i.e. the vehicle axle is supported at least indirectly on the leaf spring units (or vice versa).

At a rear end, the leaf spring unit is pivotably connected (via a second pivot axis) to a connecting arm (which can also be referred to as a swing joint), which is in turn pivotably connected (via a third pivot axis) to the vehicle structure. It is also possible to provide a plurality of connecting arms or the one connecting arm can be designed in multiple parts. Each of the connecting arms is preferably designed to be inherently rigid. In each case, a mobility of the rear end of the leaf spring unit relative to the vehicle structure is produced by the respective connecting arm. That is to say that, whilst the front end is at least substantially positionally fixed relative to the vehicle structure and can only pivot about the first axis, the rear end can be displaced relative to the vehicle structure owing to the indirect attachment via the connecting arm. It is thus possible to compensate the deformation of the leaf spring unit upon its deflection. For example, a semi-elliptical leaf spring is stretched during the deflection so that the spacing between the two ends increases. The first, the second and the third pivot axis normally extend parallel to the transverse axis (Y axis) of the vehicle. The movements of the respective spring arrangement take place within the X-Z plane here. The fundamental construction of the axle assembly corresponds to a Hotchkiss suspension.

According to one or more embodiments, the axle assembly has a control unit, which is designed to control the drive unit during cornering such that, in relation to a wheel on the inside of the curve, a wheel on the outside of the curve is acted upon by an additional driving torque. The control unit here is connected to the drive unit for the purpose of transmitting control signals and can possibly also be at least partly integrated in said drive unit. However, the control unit can also be fully or partly arranged in a totally different region of the vehicle from the drive unit and/or the vehicle axle. Parts of the control unit can also be realized via software. In addition to controlling the drive unit, the control unit can also assume other functions, i.e., in functional terms, it does not have to be associated exclusively with the drive unit. If the vehicle is located in a curve, the control unit is designed to react to this. In this case, the control unit can either itself determine, via suitable integrated sensors, whether the vehicle is located in a curve or it can be designed to receive an externally generated signal which informs it of the occurrence of cornering and possibly further cornering parameters.

As a reaction to the occurrence of cornering, the control unit controls the drive unit such that, in relation to a wheel on the inside of the curve, the wheel on the outside of the curve receives an additional driving torque. It goes without saying here that a driving torque is a torque which has an effect on a forward rotation of the wheel or on an acceleration of this forward rotation. In general terms, this means that the difference between the torque of the wheel on the outside of the curve and the torque of the wheel on the inside of the curve is positive, if a driving torque can be defined as positive.

All in all, this difference in the torques on the two wheels results in different forces being produced between the wheel on the outside of the curve and the road on the one hand and the wheel on the inside of the curve and the road on the other. This in turn results in a torque on the vehicle axle, which is effective with respect to the vertical axis (or yaw axis or Z axis). The corresponding torque at least brings about a restriction of the oversteer here; it generally brings about understeer of the vehicle axle. It could also be said that the wheel on the outside of the curve is pushed forward more strongly relative to the vehicle structure than the wheel on the inside of the curve, if the latter is pushed forward at all. In that the horizontal and the vertical position of the axle in a Hotchkiss suspension are linked to one another to a certain extent, the additional driving torque also restricts the suspension of the wheel on the outside of the curve in relation to the wheel on the inside of the curve. Owing to the control of the torques according to the disclosure, there is no need to ensure a higher spring rate of the leaf spring units in order to restrict oversteer. In some circumstances, the leaf spring units can therefore also be designed to be lighter and to save on material. Moreover, in contrast to the solution according to the invention, it is not possible to initiate understeer with an increase in the spring rate.

Within the scope of the disclosure, it is essentially conceivable that the drive unit comprises an internal combustion engine or is mechanically coupled to this and therefore the wheels are ultimately driven via the internal combustion engine. However, the wheels are preferably electrically drivable by the drive unit since it is thus possible to achieve better precision of the control of the respective wheels. This also includes embodiments in which the different drive is realized partly by an internal combustion engine and partly by an electric drive.

The drive unit here can be arranged in the region of the rigid axle and, in particular, directly on the rigid axle. In this case, the drive unit has at least one electric motor which can be powered for example via a battery, which can in turn be charged via a generator which is coupled, for example, to an internal combustion engine. In addition, it goes without saying that the at least one electric motor can also be intermittently operated as a generator in order to charge the battery, for example when the vehicle is braked or when it is sufficient to use the internal combustion engine as the drive.

The control unit is preferably designed to apply a braking torque to the wheel on the inside of the curve. That is to say that, during cornering, the control unit attempts to generate a torque on the wheel on the inside of the curve which counteracts the forward movement of said wheel and generally slows it down. It goes without saying that the understeer effect can be further improved as a result of the simultaneous occurrence of a driving moment on the wheel on the outside of the curve and a braking torque on the wheel on the inside of the curve.

According to one embodiment, the control unit is designed to generate the braking torque at least partly by means of a wheel brake associated with the wheel on the inside of the curve. That is to say that a brake, which is also used for example during normal braking maneuvers, is specifically controlled on one side during cornering to brake the wheel on the inside of the curve. There are no restrictions here in terms of the functionality of the wheel brake.

Alternatively or additionally to this, the control unit can be designed to generate the braking torque at least partly by means of the drive unit. In the case of an electric motor of the drive unit, for example, this can mean that a corresponding torque is motor-generated thereby. It is also alternatively conceivable that the corresponding electric motor is operated as a generator which is coupled to the wheel on the inside of the curve, whereby it likewise produces a braking torque.

The different drive of the two wheels can be realized in different ways. According to one embodiment, the drive unit has two electric drives, wherein each drive is associated with one of the wheels in order to drive this wheel individually. Each electric drive normally has an electric motor here (possibly also more) and optionally a gear via which the force of the electric motor is transmitted to the wheel.

The drive unit can alternatively have a regulated differential via which both wheels are driven. On the one hand, with a regulated differential of this type, a driving force, which is transmitted to the two wheels via a differential gear, is normally generated via an electric motor, which can be referred to as a drive motor. The variable distribution of the driving moments to the two wheels is conventionally adjusted by a further electric motor coupled to the differential gear. This latter electric motor can also be referred to as a torque vectoring motor or torque distribution motor.

As outlined above, the cause of the oversteer which occurs with conventional Hotchkiss suspensions during lateral acceleration (namely the centrifugal acceleration) is the unequal deflection during cornering which leads to unequal rearward movements of both wheels as a result of the axle kinematics and therefore to an oversteering self-steering of the axle, which manifests itself as oversteer, i.e. an unstable driving state of the vehicle. In this regard, there is a connection between the strength of the lateral acceleration which occurs and the necessary additional torque on the wheel on the outside of the curve. The control unit is therefore preferably designed to adjust the additional driving torque depending on a lateral acceleration effective during cornering. The lateral acceleration here could be measured for example directly via acceleration sensors, although this could lead to errors if the vehicle is traveling for example on a road profile with a slight lateral inclination. The steering angle of the steered wheels and the speed of the vehicle could therefore be detected for example in an alternative manner from which the lateral acceleration can be derived.

Further advantageous details and effects are explained in more detail below with reference to representative embodiments illustrated in the figures.

### BRIEF DESCRIPTION OF THE DRAWINGS

FIG. 1 is a schematic side view of a vehicle having an axle assembly according to one or more embodiments;

FIG. 2 is a schematic view from below of the vehicle of FIG. 1; and

FIG. 3 is a schematic view from below of a vehicle having an alternative embodiment of an axle assembly.

### DETAILED DESCRIPTION

As required, detailed embodiments are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

In the different figures, the same parts are denoted by the same reference signs and are therefore generally only described once.

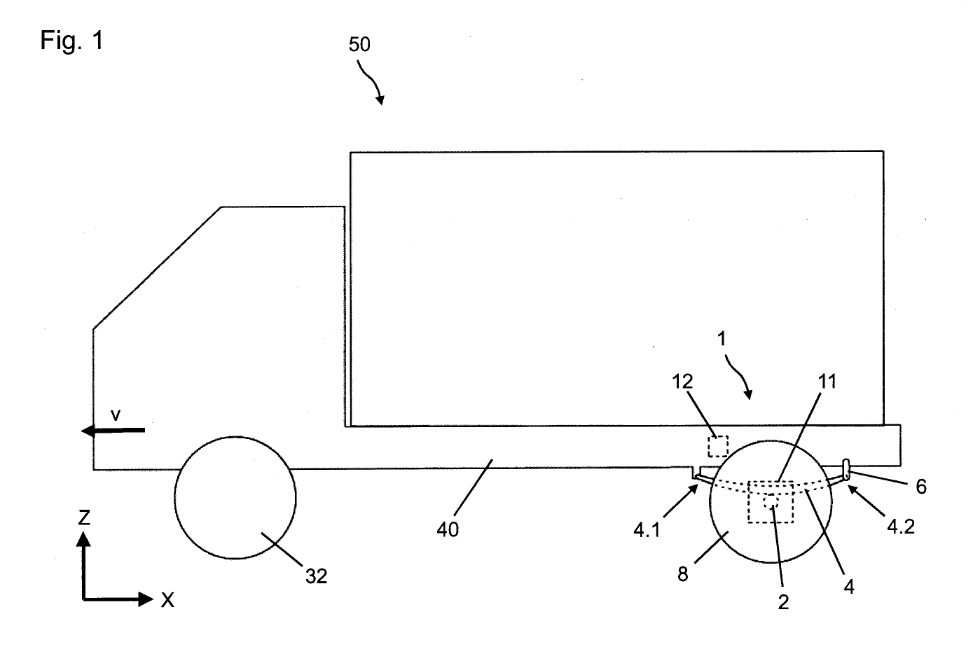

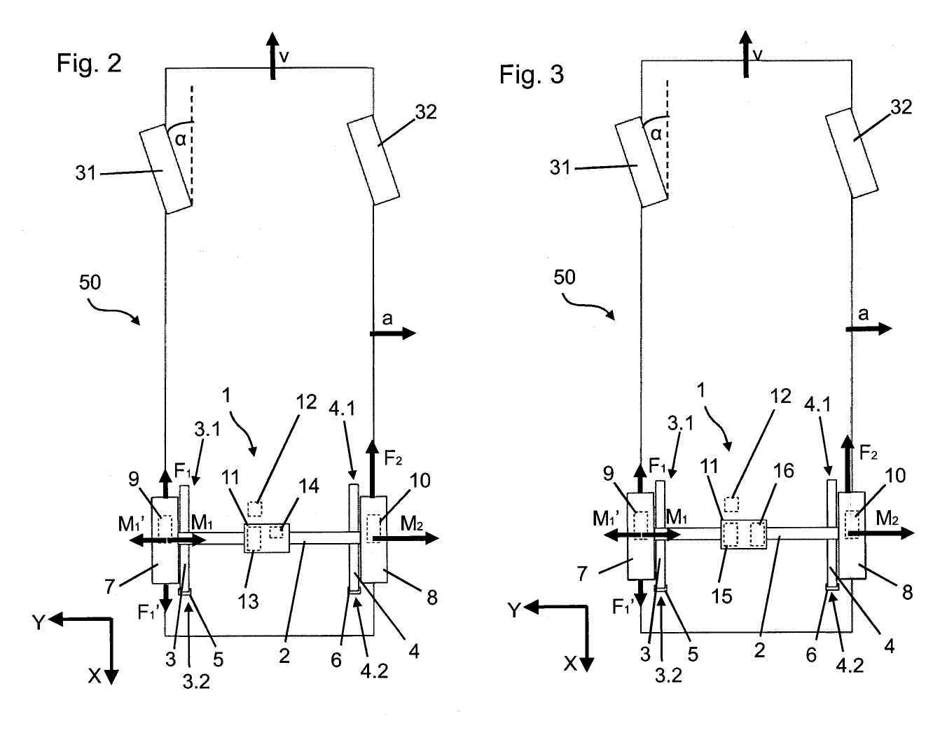

FIGS. 1 and 2 show various views of a motor vehicle 50, for example a truck or a van, having an axle assembly 1 according to at least one embodiment. The illustration here is highly schematic and simplified. A rear axle 2, which is designed as a rigid axle and extends parallel to the Y axis, is fastened to two leaf springs 3, 4, which extend substantially in the direction of the X axis and via which the vehicle axle 2 is fastened to a vehicle structure 40, for example a vehicle frame, in a sprung manner. The leaf springs 3, 4, which are designed as semi-elliptical springs in the present example, can be manufactured in particular from spring steel or possibly fiber-reinforced plastics material. The leaf springs 3, 4 form leaf spring units here, which could alternatively be designed as packs of a plurality of leaf springs.

A first wheel 7 and a second wheel 8 are arranged at the ends of the rear axle 2. A wheel brake 9, 10, which can be designed in any manner, for example as a drum brake or disk brake, is associated with each wheel here.

Each leaf spring 3, 4 is pivotably connected at a front end 3.1, 4.1 to the vehicle structure 40. The respective leaf spring 3, 4 is pivotably connected at a rear end 3.2, 4.2 to a connecting arm 5, 6, which is in turn pivotably connected to the vehicle structure 40. The structure shown here therefore corresponds to a Hotchkiss suspension. All in all, the connecting arms 5, 6 enable a movement of the rear end 3.2, 4.2 within the X-Z plane; more precisely, a rotation about the pivot axis of the connecting arm 5, 6 relative to the vehicle structure 40, whereby the deformation of the leaf springs 3, 4 during the deflection can be compensated.

The axle assembly 1 moreover has a drive unit 11, via which the two wheels 7, 8 can be driven differently. That is to say that each of the wheels can be acted upon by a different torque. The distribution of the torques to the two wheels 7, 8 here is controlled by a control unit 12, which is connected to the drive unit 11. The control unit 12 can be arranged near to the drive unit 11 here, as illustrated schematically in FIG. 1, or in a further remote part of the vehicle 50. In the illustrated example, the drive unit 11 has an electrically operated drive motor 13, a differential gear (not illustrated) and a torque distribution motor 14, which controls the actual distribution of the torques via the differential gear.

FIG. 2 shows the vehicle during cornering, during which two front wheels 31, 32 are set at a steering angle α. The vehicle 50 is traveling at a speed v, which leads to a lateral acceleration a. This lateral acceleration a in turn leads to a higher load on the wheel 8 on the outside of the curve relative to the wheel 7 on the inside of the curve. With a conventional Hotchkiss suspension, this results in a stronger deflection of the wheel 8 on the outside of the curve, which in turn leads to a stronger rearward excursion of the wheel 8 on the outside of the curve in relation to the wheel 7 on the inside of the curve. Therefore, a rotation of the rear axle 2 about the Z axis is produced, which would lead to oversteer.

This is at least partly prevented by the intervention of the control unit 12. The control unit 12 receives the steering angle α and the speed v and, from this, determines the lateral acceleration a. It goes without saying that alternative methods of determining the lateral acceleration a are also conceivable. Depending on the lateral acceleration a, the control unit 12 determines two torques Mi, M₂ for the two wheels 7, 8. As indicated in FIG. 2, the wheel 4 on the outside of the curve here is acted upon by a higher driving torque M₂ than the wheel 7 on the inside of the curve. This in turn leads to a forwardly-directed force F₂ being produced between the wheel 8 on the outside of the curve and the road, which force is greater than a force F₁ effective between the wheel 7 on the inside of the curve and the road. All in all, therefore, the wheel 8 on the outside of the curve is pulled forward at least in relation to the wheel 7 on the inside of the curve, which at least restricts the oversteer and ideally brings about understeer.

The effect can be reinforced in that a braking torque M₁′, which leads to a rearwardly-directed force F₁′, is generated on sides of the wheel 7 on the inside of the curve. This can be generated exclusively by the drive unit 11, for example. Alternatively or additionally, the control unit 12 can also control the wheel brake 9 associated with the wheel 7 on the inside of the curve for this purpose.

FIG. 3 shows, in a view from below, an alternative embodiment of an axle assembly 1 which, for the most part, is identical to the embodiment illustrated in FIG. 2. However, in this case, the drive unit 11 has two separate drive motors 15, 16, each of which is associated with one of the wheels 7, 8. By controlling the drive motors 15, 16 accordingly, it is also possible in this case for the wheel 8 on the outside of the curve to be acted upon by a driving torque M₂ which is greater than a driving torque M₁ or braking torque M₁′ effective on the wheel 7 on the inside of the curve. It goes without saying that the braking torque M₁′ here can also be fully or partly generated by the control of the wheel brake 9.

While representative embodiments are described above, it is not intended that these embodiments describe all possible forms of the claimed subject matter. The words used in the specification are words of description rather than limitation, and it is understood that various changes may be made without departing from the spirit and scope of the disclosure. Additionally, the features of various implementing embodiments may be combined to form further embodiments that are not specifically described or illustrated.

What is claimed is:

1. A vehicle comprising:
a body structure;
a rear axle connecting two rear wheels and carried by two leaf spring units, each leaf spring unit being pivotably connected at one end to the body and at another end to a connection arm pivotably connected to the body, wherein the rear axle includes two driveshafts connecting the rear wheels; and
a drive unit supported by the rear axle to be self-supporting relative to the body, the drive unit including an electric motor coupled to at least one of the two drive shafts; and
a controller configured to control the electric motor in response to lateral acceleration of the vehicle during cornering to deliver increased driving torque to an outer one of the two rear wheels relative to an inner one of the two rear wheels.

2. The vehicle of claim 1 further comprising a drum or disc brake associated with each of the two rear wheels, wherein the controller is further configured to control the drum or disc brake for the outer rear wheel to apply a braking torque during the cornering.

3. The vehicle of claim 1 wherein the electric motor is coupled to the outer one of the two rear wheels, the vehicle further comprising a second electric motor in communication with the controller and coupled to the inner one of the two rear wheels.

4. The vehicle of claim 3 wherein the controller is further configured to control the second electric motor to apply a regenerative braking torque to the inner wheel during the cornering.

5. The vehicle of claim 1 wherein the controller is further configured to calculate the lateral acceleration based on a steering angle and speed of the vehicle during the cornering.

6. The vehicle of claim 1 wherein the drive unit comprises a differential configured to couple the two drive shafts to the electric motor.

7. The vehicle of claim 1 wherein the controller is further configured to apply the increased driving torque to the outer one of the two rear wheels by applying a braking torque to the inner one of the two rear wheels.

8. The vehicle of claim 7 wherein the controller is configured to control the electric motor to apply the braking torque.

9. The vehicle of claim 7 wherein the vehicle comprises a disc or drum brake associated with each of the two rear wheels, wherein the controller is configured to control the disc or drum brake to apply the braking torque.

10. A vehicle having a rear axle connecting rear wheels, and a drive unit having an electric motor coupled to the rear wheels with the rear axle and drive unit carried by leaf spring units, comprising:
a controller configured to control the electric motor responsive to lateral acceleration of the vehicle during cornering to deliver increased driving torque to an outer one of the rear wheels relative to an inner one of the rear wheels.

11. The vehicle of claim 10 further comprising a disc or drum brake associated with each of the rear wheels and in communication with the controller, wherein the controller is further configured to control the disc or drum brake of the inner one of the rear wheels during the cornering so that the driving torque of the outer one of the rear wheels exceeds the driving torque of the inner one of the rear wheels.

12. The vehicle of claim 10 wherein the electric motor is coupled to a first one of the rear wheels, the vehicle further comprising a second electric motor in communication with the controller and coupled to a second one of the rear wheels.

13. The vehicle of claim 12 wherein the controller is further configured to control one of the electric motor and the second electric motor to provide regenerative braking torque to the inner one of the rear wheels.

14. The vehicle of claim 12 wherein the controller is further configured to control one of the electric motor and the second electric motor to provide regenerative braking torque to the inner one of the rear wheels, and the other of the electric motor and the second electric motor to provide increased driving torque to the outer one of the rear wheels.

15. A vehicle comprising:
a rear axle coupled by leaf spring units to a vehicle structure;
a drive unit supported by the rear axle comprising first and second electric motors coupled to respective ones of two rear wheels; and
a controller configured to control the electric motors responsive to lateral acceleration of the vehicle to provide more driving torque to a selected one of the two rear wheels than another of the two rear wheels.

16. The vehicle of claim 15 wherein the controller is configured to control one of the motors to provide braking torque to the another of the two rear wheels during cornering.

17. The vehicle of claim 15 wherein the controller calculates lateral acceleration based on a steering angle and speed of the vehicle.

18. The vehicle of claim 15 further comprising a drum or disc brake associated with each of the two rear wheels, wherein the controller is further configured to control the drum or disc brake to provide a braking torque responsive to the lateral acceleration.
